(19) United States
(12) Patent Application Publication
(10) Pub. No.: US 2023/0332956 A1
(43) Pub. Date: Oct. 19, 2023

(54) DISASTER PREVENTION AND WARNING SYSTEM

(71) Applicant: DIRECTLYTEK TECHNOLOGY CO., LTD., Hsinchu City (TW)

(72) Inventor: Shih-Hao TANG, Hsinchu City (TW)

(21) Appl. No.: 17/722,686

(22) Filed: Apr. 18, 2022

(51) Int. Cl. G01K 3/00; G01K 1/02; G01K 1/024; F16L 53/38; H05B 1/02

(52) U.S. Cl. CPC G01K 3/005; G01K 1/026; G01K 1/024; F16L 53/38; H05B 1/0244

(57) ABSTRACT

A disaster prevention and warning system is used to monitor an electrical thermal insulation system for a pipeline. The electric thermal insulation system includes a plurality of heaters and a plurality of temperature controllers, each of which is electrically connected to first and second electrical connectors, respectively. The disaster prevention and warning system includes pluralities of first and second thermocouples and a human-machine interface controller. The human-machine interface controller includes a programmable controller and a warning device, and the programmable controller is electrically connected to the warning device. The programmable controller judges if the temperature of the heater is higher than the first warning temperature value or if the temperature of the first electrical connector is higher than the second warning temperature value. The warning device generates a warning message, providing convenience of inspection and maintenance to the electric heating and insulation system, and avoiding failure of the heaters.

### CROSS-REFERENCE TO RELATED U.S. APPLICATIONS

Not applicable.

### BACKGROUND OF THE INVENTION

### 1. Field of the Invention

The present invention relates generally to the monitoring of overheating of heaters, and more particularly to a disaster prevention and warning system. The disaster prevention and warning system is used to monitor electrical thermal insulation systems mainly made up of a plurality of heaters. The heaters enclose and cover a pipeline to provide thermal insulation and heating to the pipeline.

### 2. Description of Related Art Including Information Disclosed Under 37 CFR 1.97 and 37 CFR 1.98.

In order to convey specific types of materials during the production process, the pipeline needs to be insulated so that the pipeline can be maintained within a certain range of temperatures, and the material inside the pipeline will not deposit or jam the pipeline. Apart from insulation means to reduce the speed of heat loss, timely replenishment of thermal energy can help maintain the temperature of the pipeline. In order to meet the above requirement, some manufacturers have developed a kind of heaters that can enclose the pipeline.

The heater comprises a heat insulation structure and an electric heating structure, wherein the heat insulation structure is made of heat-insulating materials. The electric heating structure is configured on one side of the heat insulation structure. When the heaters are configured on the periphery of a pipeline, the electric heating structure is located between the heat insulation structure and the pipeline. The electric heating structure supplies thermal energy to the pipeline, to replenish the lost thermal energy of the pipeline. The heat insulation structure can reduce dissipation of thermal energy from the pipeline and the electric heating structure.

Based on the shape and length of the pipeline, dozens or even hundreds of heaters are configured along the pipeline, so as to form an electrical thermal insulation system. The electrical thermal insulation system comprises a plurality of heaters and a plurality of temperature controllers, wherein each temperature controller is coupled with each heater, each temperature controller respectively controls the electric heating structure coupled with the heater. The temperature controller is electrically connected to a first electrical connector and a second electrical connector. The first electrical connector and the second electrical connector are in male and female connection. Each first electrical connector is electrically connected to the adjacent second electrical connector. The temperature controllers are connected in series. Electricity is supplied to each of the temperature controllers and heaters through each of the first electrical connectors and each of the second electrical connectors.

Each of the temperature controllers controls the electric current supplied to its corresponding heater, so as to control the heat generated by the electric heating structure. When the temperature of the heater is higher than the preset temperature, the temperature controller will actuate the overheat auto power-off mechanism to stop supply electric power to the heater and to avoid burning of the heater or the pipeline.

When electricity is not supplied to the heater, the pipeline cannot obtain thermal energy, and the temperature in the pipeline will gradually decrease. As a result, the material conveyed inside the pipeline may deposit or jam the pipeline, leading to interruption of the production. In some cases, the pipelines need to be dismantled to clear the material deposited inside the pipeline, or even there is a need to replace the pipelines. The overheat auto power-off mechanism can prevent the heaters to become too hot to cause dangerous accidents of burning, but it can also lead to great loss of production cost or equipment cost.

Electricity is supplied to each temperature controller through each first electrical connector and each second electrical connector in male and female connection. The first electrical connector and the second electrical connector are not provided with overheat protection. In case any of the first electrical connectors or the second electrical connectors is overheated and damaged due to high magnitude of electric current, the heater will shut down due to outage of electric power supply, leading to the problem of deposit and jam inside the pipeline, as mentioned above.

### BRIEF SUMMARY OF THE INVENTION

The main object of the invention is to provide a disaster prevention and warning system for electrical thermal insulation systems.

Based on the above object, the problem-solving technical feature of the invention mainly lies in that the disaster prevention and warning system is used to monitor an electrical thermal insulation system, and the electrical thermal insulation system is used for thermal insulation and heating of the pipeline.

The electrical thermal insulation system comprises a plurality of heaters and a plurality of temperature controllers, wherein said heaters enclose the pipeline, and each heater comprises an electric heating structure. The electric heating structure provides thermal energy to the pipeline. Each temperature controller is respectively and electrically connected to each heater, so as to control the electric heating structure to heat up. Each temperature controller is respectively and electrically connected to a first electrical connector and a second electrical connector. Each first connector is respectively and electrically connected to the adjacent second connector, so that the temperature controllers are connected in series, through each first electrical connector and each second electrical connector. A power source supplies electric power to each of the temperature controllers and each of the heaters.

The disaster prevention and warning system comprises a plurality of first thermocouples, a plurality of second thermocouples and a human-machine interface controller, wherein each first thermocouple is configured in correspondence with each of the heaters. One end of the first thermocouple is configured on the side of the heater facing the pipeline, and the other end of the first thermocouple is connected to the corresponding temperature controller, so as to detect the temperature of the heater, and to transmit the detected temperature value to the temperature controller. One end of the second thermocouple is configured on the first electrical connector. The other end of the second thermocouple is connected to the corresponding temperature controller, so as to detect the temperature of the first electrical connector, and to transmit the detected temperature value to the temperature controller. The first electrical connector and the second electrical connector is respectively connected to two first communication cables. Each first communication cable is respectively connected to the corresponding temperature controller

The human-machine interface controller is connected to a second communication cable. The second communication cable is coupled with each first communication cable. Each temperature controller respectively transmits the temperature values of each heater and each first electrical connector to the human-machine interface controller through the first communication cable and the second communication cable. The human-machine interface controller comprises a programmable controller and a warning device, wherein the programmable controller is electrically connected to the warning device.

The temperature of the heater is defined as first temperature value. The temperature of the first electrical connector is defined as second temperature value. The temperature controller transmits the first temperature value and the second temperature value to the human-machine interface controller. The programmable controller makes a comparison to judge if the first temperature value is higher than the preset first warning temperature value, or if the second temperature value is higher than the preset second warning temperature value. If the first temperature value is higher than the first warning temperature value, the programmable controller controls the warning device to generate a warning message. If the second temperature value is higher than the second warning temperature value, the programmable controller controls the warning device to generate a warning message. This provides convenience to the inspection and maintenance of the electrical thermal insulation system, and to avoid failure of the heaters.

The main efficacy and advantage of the invention is that it can provide monitoring and warning of the temperature of the heaters and the first electrical connectors, so as to avoid accidental burning, and to avoid actuation of the auto power-off mechanism due to overheat of the heaters or the first electrical connectors, thus avoiding deposit of materials inside the pipelines to cause jam of the pipelines.

### BRIEF DESCRIPTION OF THE SEVERAL VIEWS OF THE DRAWINGS

FIG. 1 is a sectional view of a heater configured on a pipeline.

FIG. 2 is an electric circuit diagram showing the application of Embodiment 1 of the invention in an electrical thermal insulation system.

FIG. 3 is a wiring diagram of the first electrical connector, second electrical connector and temperature controller in Embodiment 1 of the invention.

FIG. 4 is a monitoring screen of the warning device in Embodiment 1 of the invention.

FIG. 5 is another monitoring screen of the warning device in Embodiment 1 of the invention.

FIG. 6 is a flow chart of the execution of the disaster prevention and warning in Embodiment 1 of the invention.

FIG. 7 is the wiring diagram of the first electrical connector, second electrical connector and temperature controller in Embodiment 2 of the invention.

### DETAILED DESCRIPTION OF THE INVENTION

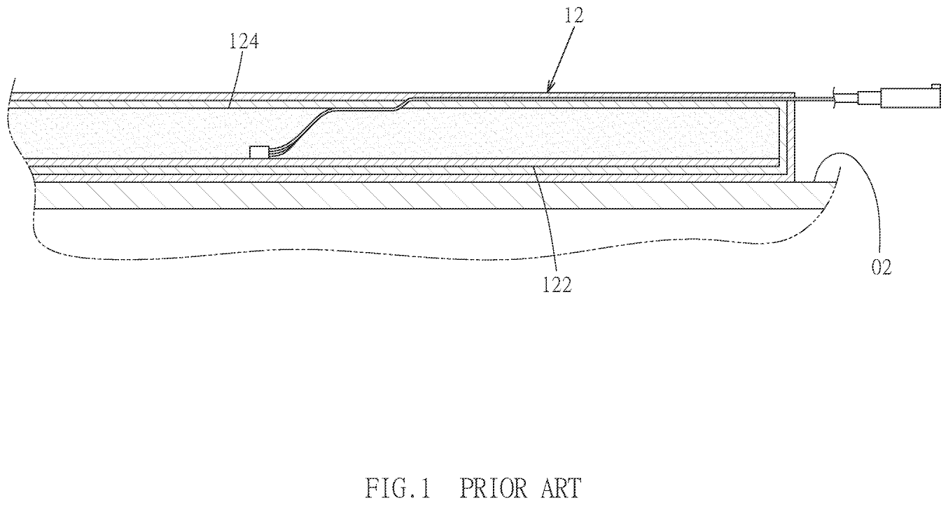

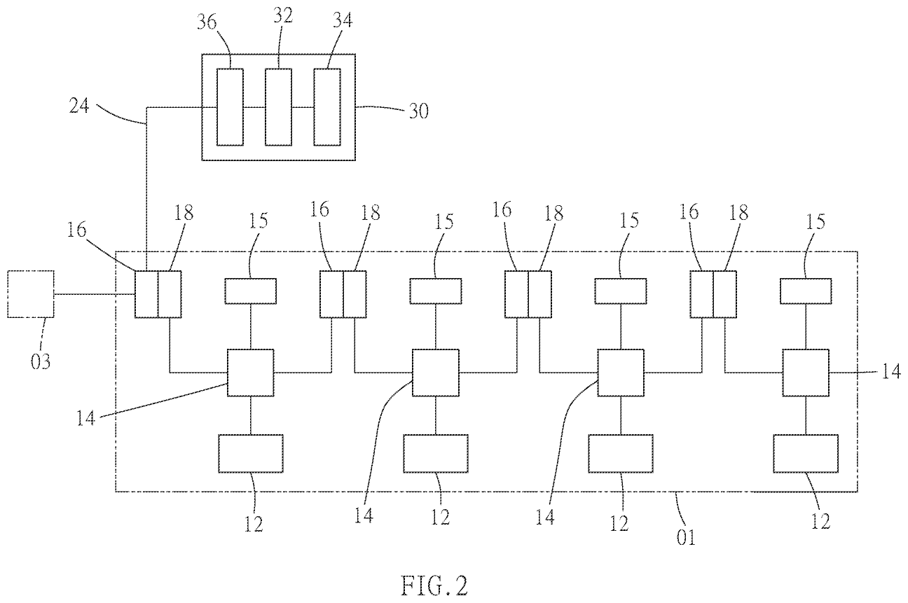

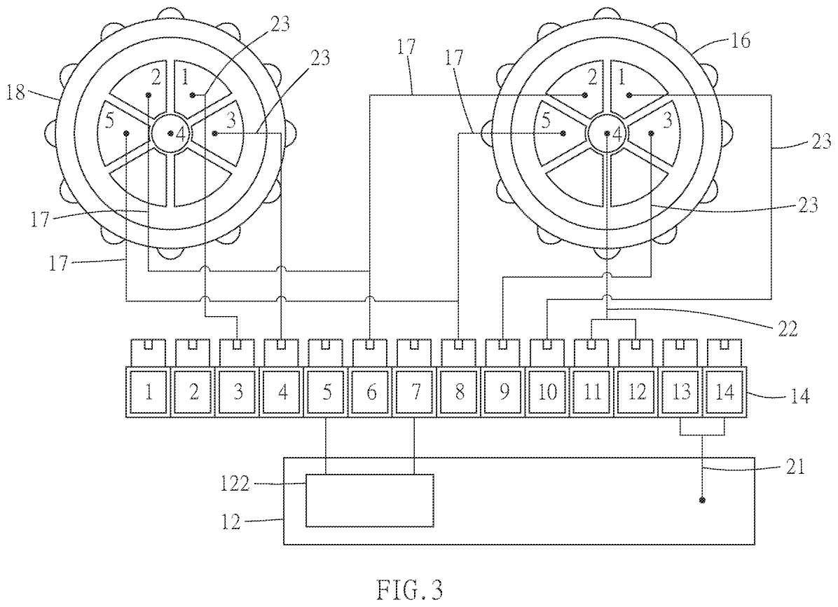

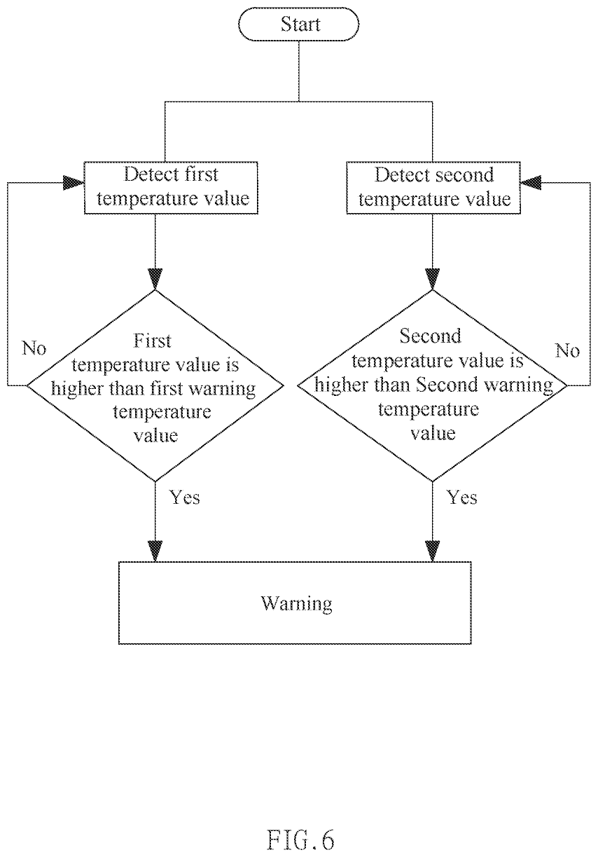

Depicted in FIG. 1 to FIG. 6 is a disaster prevention and warning system used to monitor an electrical thermal insulation system 01 according to the invention. The electrical thermal insulation system 01 provides thermal insulation and heating to a pipeline 02. The electrical thermal insulation system 01 comprises a plurality of heaters 12 and a plurality of temperature controllers 14, wherein said heaters 12 enclose the pipeline 02. Each heater 12 comprises an electric heating structure 122. Said electric heating structure 122 provides thermal energy to the the pipeline 02. The electric heating structure 122 is prior art known by those skilled in the art, and therefore the structure of the electric heating structure 122 is not detailed here. The temperature controllers 14 are mainly made up of PID controllers. Each temperature controller 14 is respectively and electrically connected to each heater 12, so as to control the electric heating structure 122 to heat up. Each temperature controller 14 is respectively and electrically connected to a first electrical connector 16 and a second electrical connector 18. Each first electrical connector 16 is respectively and electrically connected to the adjacent second electrical connector 18. The first electrical connector 16 and the second electrical connector 18 are respectively connected to the electric power transmission line 17, so that the temperature controllers 14 are connected in series. Through each first electrical connector 16 and each second electrical connector 18, a power source 03 supplies electric power to each of the temperature controllers 14 and each of the heaters 12.

Embodiment 1 of the disaster prevention and warning system according the invention comprises a plurality of first thermocouples 21, a plurality of second thermocouples 22 and a human-machine interface controller 30, wherein each first thermocouple 21 is configured in correspondence with each of the heater 12, one end of the first thermocouple 21 detecting the temperature is configured on the side of the heater 12 facing the pipeline 02, the other end of the first thermocouple 21 is connected to the corresponding temperature controller 14, so as to detect the temperature of the heater 12, and to transmit the detected temperature value to the temperature controller 14, one end of the second thermocouple 22 detecting the temperature is configured on the first electrical connector 16, the other end of the second thermocouple 22 is connected to the corresponding temperature controller 14, so as to detect the temperature of the first electrical connector 16, and to transmit the detected temperature value to the temperature controller 14, the first electrical connector 16 and the second electrical connector 18 are respectively connected to two first communication cables 23, and each first communication cable 23 is respectively connected to the corresponding temperature controller 14.

The human-machine interface controller 30 is connected to a second communication cable 24. The second communication cable 24 is coupled with each first communication cable 23. Each temperature controller 14 respectively transmits the temperature values of each heaters 12 and each first electrical connector 16 to the human-machine interface controller 30 through the first communication cable 23 and the second communication cable 24. The human-machine interface controller 30 comprises a programmable controller 32 and a warning device 34, wherein the programmable controller 32 is electrically connected to the warning device 34. In the present embodiment, the warning device 34 is a monitor used to display a visual message that can be recognized by eyes.

The temperature of the heater 12 is defined as first temperature value, and the temperature of the first electrical connector 16 is defined as second temperature value. The temperature controller 14 transmits the first temperature value and the second temperature value to the human-machine interface controller 30. The programmable controller 32 makes a comparison to judge if the first temperature value is higher than the preset first warning temperature value, or if the second temperature value is higher than the preset second warning temperature value. If the first temperature value is higher than the first warning temperature value, the programmable controller 32 will control the warning device 34 to generate a warning message. If the second temperature value is higher than the second warning temperature value, the programmable controller 32 will control the warning device 34 to generate a warning message. The warning messages can provide convenience to the inspection and maintenance of the electrical thermal insulation system 01, and to avoid failure of the heaters 12.

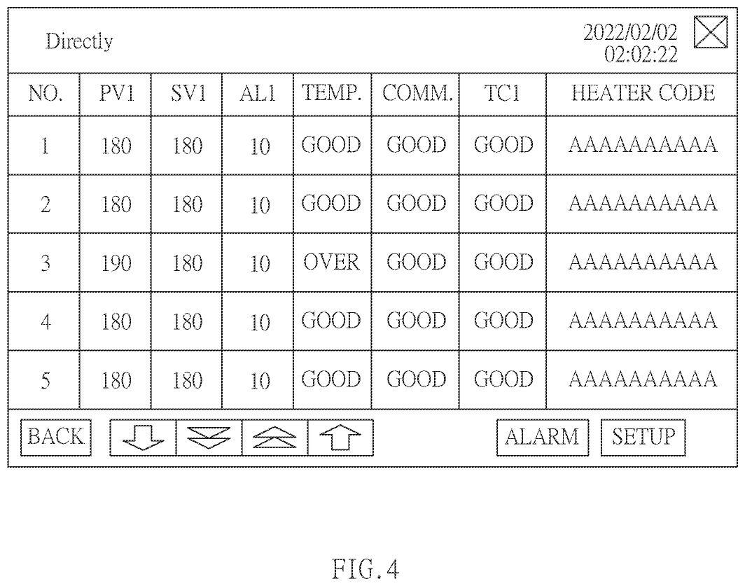

As shown in FIG. 4, the PV1 field displays the first temperature value, the SV1 field displays the first warning temperature value, the AL1 field displays the range of absolute values of (PV1−SV1) that will trigger a warning signal, the temperature field displays the temperatures under supervision. When the absolute value of (PV1−SV1) is lower than set value of the AL1 field, the temperature field displays “GOOD”, when the absolute value of (PV1−SV1) is higher than the set value of the AL1 field, the temperature field displays “OVER”. The communication field displays the signal transmission state between the human-machine interface communicator 30 and the temperature controller 14 in correspondence with the heater 12, to supervise the normal/abnormal state of communication between the human-machine interface communicator 30 and the temperature controller 14. The TC1 field displays the normal/abnormal state of temperature detection of the first thermocouple 21.

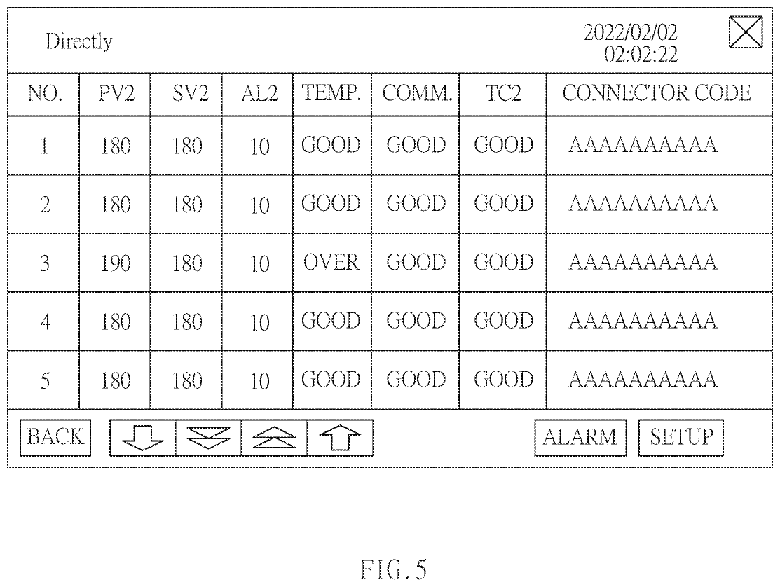

As shown in FIG. 5, the PV2 field displays the second temperature value. The SV2 field displays the second warning temperature value. The AL2 field displays the range of values of (PV2−SV2) that will trigger a warning signal. The temperature field displays the temperatures under supervision. The communication field displays the state of communication between the human-machine interface communicator 30 and the temperature controllers 14 in correspondence with the first electrical connector 16. The TC2 field displays the normal/abnormal state of temperature detection of the second thermocouple 22.

FIG. 4 and FIG. 5 are examples of monitoring screens displayed on the warning device 34, respectively. The monitors can be replaced as needed. The warning device 34 can also be replaced by a warning unit (not shown in the figure) made up of a plurality of various warning lights, so as to form a varied embodiment. The plurality of warning lights can be used to display different colors or to flash, so that a supervisor can recognize exception signals.

When the temperature of any of the heaters 12 or of any of the first electrical connectors 16 as part of the electrical thermal insulation system 01 is abnormal, the programmable controller 32 will control the warning device 34 to display a corresponding warning message, and the maintenance personnel can, according to the warning message displayed on the warning device 34, quickly identify the location of the heater 12 or the first electric connector 16 with abnormal temperature, and immediately carry out maintenance or replacement, thus avoiding potential accidents of burning. By setting the first warning temperature value and the second warning temperature value, measures can be taken before occurrence of overheat, and the actuation of auto power-off mechanism can be avoided. This can effectively reduce the length of time during which the pipeline 02 cannot obtain replenishment of heat due to abnormal temperature of the heater 12 or the first electrical connector 16, and thus can avoid deposit of the produced material inside the pipeline 02 or even jam of the pipeline 02.

Embodiment 1 can not only provide monitoring and warning for the heaters 12, but also provide monitoring and warning for the first electrical connectors 16. Through the heat conduction effect, the second temperature value detected by the second thermocouple 22 can also be used as a reference for the temperature of the second electrical connector 18 connected to the first electrical connector 16, thus providing supervision for the temperature of the second electrical connector 18 to avoid overheat and damage of the first electrical connector 16 and the second electrical connector 18, which leads to outage of electric power supplied to the heaters 12. Therefore, the number of thermocouples configured in the system can be reduced, and the wiring of the system will not be too complicated.

The human-machine interface controller 30 further comprises a communication port 36. The communication port 36 is electrically connected to the programmable controller 32. A second communication cable 24 is connected to the communication port 36.

Each temperature controller 14 is respectively connected to a monitor 15. The monitor 15 is used to display the first temperature value and the second temperature value, so as to facilitate inspection of the heaters 12 or the first electrical connectors 16 by maintenance personnel. During maintenance or replacement, according to the first temperature value and the second temperature value displayed on each monitor 15, the maintenance personnel can quickly and reliably identify which heater 12 or which first electrical connector 16 needs maintenance or replacement. Thus, the reliability and efficiency of maintenance or replacement is enhanced.

The heater 12 further comprises a heat insulation structure 124. The electric heating structure 122 is configured on one side of the heat insulation structure 124. The heat insulation structure 124 is made of aerogel combined with a nanomaterial having the function of heat insulation. When the heater 12 is configured on the pipeline 02, the electric heating structure 122 is located on the side of the heat insulation structure 124 facing the pipeline 02. The heat insulation structure 124 can reduce the dissipation of thermal energy from the pipeline 02 and the electric heating structure 122 into the environment.

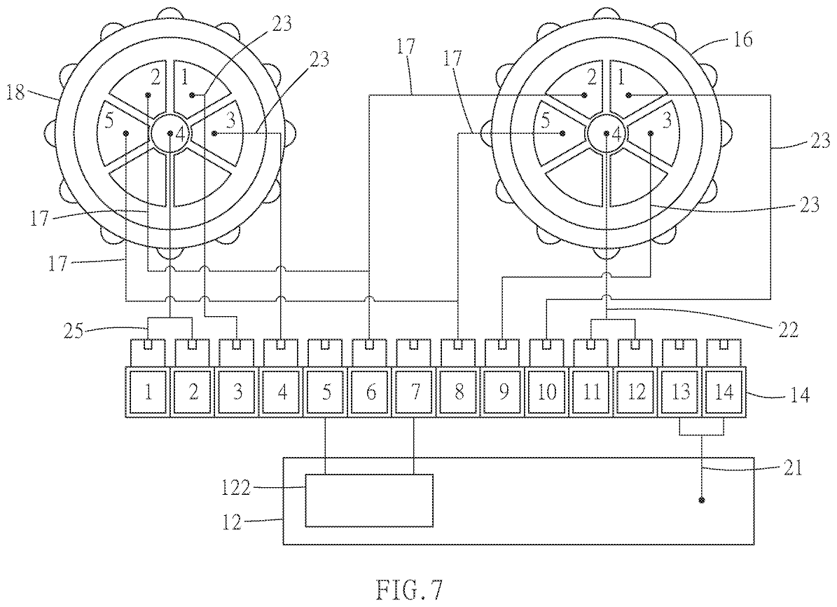

Referring to FIG. 7, Embodiment 2 is a variation of Embodiment 1. Embodiment 2 further comprises a plurality of third thermocouples 25, wherein the end of the third thermocouples 25 that detects temperature is configured on the second electrical connector 18, the other end of the third thermocouple 25 is connected to the temperature controller 14, so as to detect the temperature of the second electrical connector 18, and to transmit the detected temperature value to the temperature controller 14. Embodiment 2 can further enhance the reliability of temperature monitoring and warning for the second electrical connector 18.

I claim:

1. A disaster prevention and warning system, used to monitor an electrical thermal insulation system, said electrical thermal insulation system provides thermal insulation and heating to a pipeline;
the electrical thermal insulation system comprises a plurality of heaters and a plurality of temperature controllers, wherein said heaters enclose the pipeline, each heater comprise an electric heating structure, said electric heating structure provides thermal energy to the pipeline, each temperature controller is respectively and electrically connected to each heater, so as to control the electric heating structure to heat up, each temperature controller is respectively and electrically connected to a first electrical connector and a second electrical connector, each first connector is respectively and electrically connected to the adjacent second connector, so that the temperature controllers are connected in series, through each first electrical connector and each second electrical connector, a power source supplies electric power to each of the temperature controllers and each of the heaters;
the disaster prevention and warning system comprises a plurality of first thermocouples, a plurality of second thermocouples and a human-machine interface controller, wherein each first thermocouple is configured in correspondence with each of the heaters, one end of the first thermocouple is configured on the side of the heater facing the pipeline, the other end of the first thermocouple is connected to the corresponding temperature controller, so as to detect the temperature of the heater, and to transmit the detected temperature value to the temperature controller, one end of the second thermocouple is configured on the first electrical connector, the other end of the second thermocouple is connected to the corresponding temperature controller, so as to detect the temperature of the first electrical connector, and to transmit the detected temperature value to the temperature controller, the first electrical connector and the second electrical connector is respectively connected to two first communication cables, each first communication cable is respectively connected to the corresponding temperature controller;
the human-machine interface controller is connected to a second communication cable, the second communication cable is coupled with each first communication cable, each temperature controller respectively transmits the temperature values of each heater and each first electrical connector to the human-machine interface controller through the first communication cable and the second communication cable, the human-machine interface controller comprises a programmable controller and a warning device, wherein the programmable controller is electrically connected to the warning device;
the temperature of the heater is defined as first temperature value, the temperature of the first electrical connector is defined as second temperature value, the temperature controller transmits the first temperature value and the second temperature value to the human-machine interface controller, the programmable controller makes a comparison to judge if the first temperature value is higher than the preset first warning temperature value, or if the second temperature value is higher than the preset second warning temperature value, if the first temperature value is higher than the first warning temperature value, the programmable controller controls the warning device to generate a warning message, if the second temperature value is higher than the second warning temperature value, the programmable controller controls the warning device to generate a warning message, this provides convenience to the inspection and maintenance of the electrical thermal insulation system, and to avoid failure of the heaters.

2. The disaster prevention and warning system defined in claim 1, which further comprises a plurality of third thermocouples, wherein one end of the third thermocouple is configured on the second electrical connector, the other end of the third thermocouple is connected to the temperature controllers, so as to detect the temperature of the second electrical connector, and to transmit the detected temperature value to the temperature controller.

3. The disaster prevention and warning system defined in claim 1, wherein said warning device is a monitor, the warning device displays the first temperature value and the second temperature value, and the warning message is a visual message.

4. The disaster prevention and warning system defined in claim 1, wherein said human-machine interface controller further comprises a communication port, the communication port is electrically connected to the programmable controller, and the second communication cable is connected to the communication port.

5. The disaster prevention and warning system defined in claim 1, wherein each temperature controller is respectively connected to a monitor, the monitor is used to display the first temperature value and the second temperature value, so as to enhance the convenience of inspection and maintenance.
